(19) United States
(12) Patent Application Publication
(10) Pub. No.: US 2013/0048338 A1
(43) Pub. Date: Feb. 28, 2013

(54) COATED WIRE AND METHOD OF MANUFACTURING THE SAME

(71) Applicants: Hideyuki SUZUKI, Hitachi (JP); Katsuichi FUKUCHI, Hitachi (JP)

(72) Inventors: Hideyuki SUZUKI, Hitachi (JP); Katsuichi FUKUCHI, Hitachi (JP)

(73) Assignee: HITACHI CABLE, LTD., Tokyo (JP)

(21) Appl. No.: 13/421,209

(22) Filed: Mar. 15, 2012

(30) Foreign Application Priority Data
Aug. 29, 2011 (JP) 2011-185917

(51) Int. Cl. H01B 7/00; B05D 5/12

(52) U.S. Cl. 174/120 R; 427/117

(57) ABSTRACT

A coated wire includes a core wire, one or more grooved insulation layer coating the core wire, the grooved insulation layer including a silane-crosslinked insulating resin composition and a groove on an outer surface thereof, and a sheath layer coating an outermost layer of the grooved insulation layer.

The present application is based on Japanese Patent Application No. 2011-185917 filed on Aug. 29, 2011, the entire contents of which are incorporated herein by reference.

### BACKGROUND OF THE INVENTION

1. Field of the Invention

The invention relates to a coated wire and a method of manufacturing the coated wire.

2. Description of the Related Art

In recent years, various coated wires formed of a conductor coated with a coating layer, e.g., a power wire such as an insulated wire or a communication cable such as an optical cable, are often required to have heat resistance under high temperature environment. As for a heat-resistant coated wire, although there is an example of using expensive engineering plastics as a coating layer to coat a conductor, insulating resin compositions formed by cross-linking a cheap polyolefin resin excellent in processability are often used as a coating layer.

Three types of cross-linking methods, a peroxide cross-linking method, a radiation cross-linking method and a silane cross-linking method, are used to cross-link an insulating resin composition constituting a coating layer of a coated wire. The cheap method, among the above, is the silane cross-linking method which does not require an expensive equipment as such used for the radiation cross-linking method and in which an organosilane compound is graft-polymerized onto a resin as a main raw material such as polyolefin, a catalyst is then mixed and kneaded therewith to obtain an insulating resin composition, an outer periphery of a conductor is subsequently coated with the insulating resin composition as a coating layer of a coated wire, and then cross-linking of the coating layer is promoted by naturally penetrating water in the air into the surface of the coating layer. Therefore, the silane cross-linking method is often employed as a method of cross-linking an insulating resin composition which constitutes the coating layer of the coated wire (see, e.g., JP-A-2007-70602).

JP-A-2007-70602 discloses a coated wire having a structure in which a ingle or plural insulation layers formed of a silane-crosslinked halogen-free flame-retardant thermoplastic elastomer composition are formed on an outer periphery of a conductor and also a structure in which a sheath layer (the outermost layer) is further formed on the insulation layer. The halogen-free flame-retardant thermoplastic elastomer composition used for the coated wire is cross-linked by leaving in a water-vapor atmosphere at 80° C. for 24 hours.

The silane cross-linking method is likely to be affected by temperature or humidity since hydrolysis of alkoxysilane by penetration of water through the surface and a subsequent dehydration and condensation reaction are used to promote the cross-linking, and it is thus essential to control temperature and humidity. Therefore, the wire is kept in an environment controlled to predetermined temperature and humidity for a predetermined cross-linking time immediately after forming the coating layer.

### SUMMARY OF THE INVENTION

However, the conventional coated wire has a problem in that, when using the silane cross-linking method, a predetermined cross-linking time is required for the silane cross-linking depending on a surface area of the insulation layer and a different cross-linking time is required for each layer since the outer periphery of the insulation layer has a shape without unevenness, and production efficiency of the coated wire thus declines. In addition, when the coated wire has a multi-layered structure, there is concern that adhesion between respective layers constituting the coating layer is insufficient.

Accordingly, it is an object of the invention to provide a coated wire that can decrease cross-linking time and improve adhesion of a coating layer, as well as a method of manufacturing the coated wire.

(1) According to one embodiment of the invention, a coated wire comprises:

a core wire;

one or more grooved insulation layer coating the core wire, the grooved insulation layer comprising a silane-crosslinked insulating resin composition and a groove on an outer surface thereof; and

a sheath layer coating an outermost layer of the grooved insulation layer.

In the above embodiment (1) of the invention, the following modifications and changes can be made.

(i) The groove on the grooved insulation layer is formed along an axial direction of the core wire.

(ii) The coated wire further comprises:

one or more non-grooved insulation layer comprising a silane-crosslinked insulating resin composition, the non-grooved insulation layer being formed between the grooved insulation layer and the sheath layer or between the core wire and the grooved insulation layer and having no groove on an outer surface thereof.

(iii) The insulating resin composition composing the grooved insulation layer or the non-grooved insulation layer comprises a halogen-free flame-retardant thermoplastic composition.

(2) According to another embodiment of the invention, a method of manufacturing a coated wire comprises:

extruding an insulating resin composition from an extruder having a die with a convex portion on an inner surface thereof and located at an outlet port to coat a core wire with the insulating resin composition and adhering water to the insulating resin composition, the extrusion and the water adhesion being performed once or more than once, thereby forming one or more than one grooved insulation layers that coats the core wire and has a groove on an outer periphery thereof along an axial direction of the core wire; and

forming a sheath layer for coating the outermost periphery of the grooved insulation layer.

In the above embodiment (2) of the invention, the following modifications and changes can be made.

(iv) The method further comprises:

extruding an insulating resin composition from an extruder on the fed core wire or on an outer periphery of a layer coating the core wire before or after forming the grooved insulation layer to coat the core wire or the grooved insulation layer with the insulating resin composition and adhering water to the insulating resin composition, the extrusion and the water adhesion performed once or more than once, thereby forming a non-grooved insulation layer that coats the core wire or the grooved insulation layer and does not have a groove on an outer periphery thereof.

(v) A silane cross-linking reaction of the grooved insulation layer or the non-grooved insulation layer is enhanced by adhering water to a layer inside or outside of the grooved insulation layer or the non-grooved insulation layer.

(vi) The water is adhered by dipping in water in a cooling water pool.

### EFFECTS OF THE INVENTION

According to one embodiment of the invention, a coated wire is provided that can decrease cross-linking time and improve adhesion of a coating layer, as well as a method of manufacturing the coated wire.

### BRIEF DESCRIPTION OF THE DRAWINGS

Next, the present invention will be explained in more detail in conjunction with appended drawings, wherein:

FIG. 1 is an exploded perspective view showing a coated wire in a first embodiment of the present invention;

FIG. 2 is a cross sectional view showing the coated wire shown in FIG. 1;

FIG. 3 is a schematic diagram illustrating a configuration of a manufacturing system in the first embodiment;

FIG. 4 is a perspective view showing an example of a die in the first embodiment;

FIG. 5 is a front view showing the die shown in FIG. 4;

FIG. 6 is an exploded perspective view showing a coated wire in a second embodiment of the invention;

FIG. 7 is a cross sectional view showing the coated wire shown in FIG. 6;

FIG. 8 is a schematic diagram illustrating a configuration of a manufacturing system in the second embodiment;

FIG. 9 is a schematic diagram illustrating a configuration of a manufacturing system in a modification of the second embodiment;

FIG. 10 is an exploded perspective view showing a coated wire in a third embodiment of the invention;

FIG. 11 is a cross sectional view showing the coated wire shown in FIG. 10;

FIG. 12 is a schematic diagram illustrating a configuration of a manufacturing system in the third embodiment;

FIG. 13 is a schematic diagram illustrating a configuration of a manufacturing system in a modification of the third embodiment;

FIG. 14 is an exploded perspective view showing a coated wire in a fourth embodiment of the invention;

FIG. 15 is a cross sectional view showing the coated wire shown in FIG. 14;

FIG. 16 is a schematic diagram illustrating a configuration of a manufacturing system in the fourth embodiment;

FIG. 17 is a schematic diagram illustrating a configuration of a manufacturing system in a modification of the fourth embodiment;

FIG. 18 is an exploded perspective view showing a coated wire in a fifth embodiment of the invention;

FIG. 19A is a front view showing a die used in an extrusion step for a grooved insulation layer in Example 1;

FIG. 19B is an enlarged view showing a convex portion of the die in FIG. 19A;

FIG. 20A is a front view showing a die used in an extrusion step for a grooved insulation layer in Example 2; and

FIG. 20B is an enlarged view showing a convex portion of the die in FIG. 20A.

### DETAILED DESCRIPTION OF THE PREFERRED EMBODIMENTS

Embodiments of the invention will be described below in reference to the drawings. It should be noted that components having substantially the same functions are denoted by the same reference numerals in each drawing and the duplicative explanations will be omitted.

### SUMMARY OF EMBODIMENTS

The embodiments provide a coated wire provided with a core wire, one or more than one insulation layers formed of a silane-crosslinked insulating resin composition for coating the core wire and a sheath layer for coating the outermost insulation layer, wherein the one or more than one insulation layers have grooves on an outer periphery thereof.

Here, the “core wire” includes a conductor for conducting electricity and signals, and an optical fiber composed of a core for conducting optical signals and a cladding. Meanwhile, the “coated wire” includes a wire or cable composed of a conductor, an insulation layer coating the conductor and a sheath layer further coating the insulation layer, a cable formed of plural wires twisted together and coated with a sheath layer, and an optical fiber cable formed of a single or plural optical fibers coated with an insulation layer and a sheath layer further coating thereon. The conductor may be either a solid wire or a stranded wire.

The surface area of the outer periphery of the insulation layer is increased by forming a groove thereon, silane cross-linking by a water adhesion method is thereby enhanced, and cross-linking time is reduced. In addition, since a contact area between the insulation layer having the groove and an outer layer is increased, adhesion therebetween is improved.

### First Embodiment

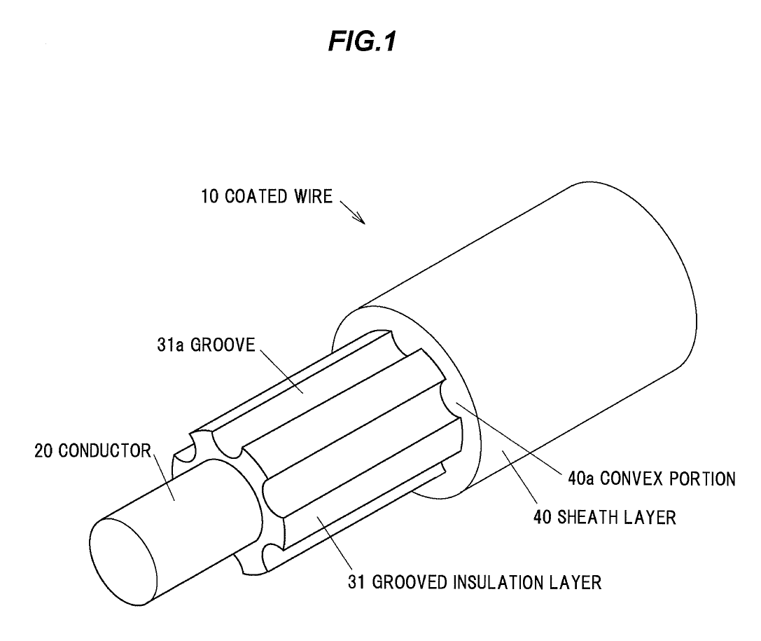

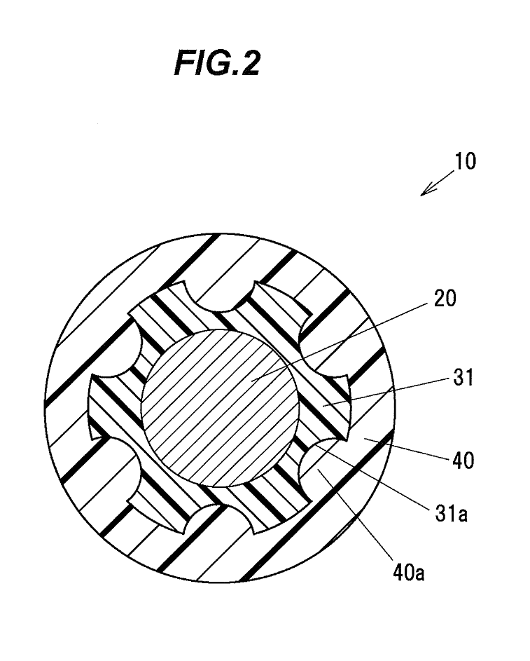

FIG. 1 is an exploded perspective view showing a coated wire in a first embodiment of the invention and FIG. 2 is a cross sectional view showing the coated wire shown in FIG. 1. A coated wire 10 has a conductor 20, a grooved insulation layer 31 coating the conductor 20 and a sheath layer 40 coating the grooved insulation layer 31. In the specification, the grooved insulation layer means an insulation layer having a groove on the outer periphery thereof. The conductor 20 is an example of a core wire. The grooved insulation layer 31 and the sheath layer 40 are examples of a coating layer.

Conductor

The conductor 20 is formed of a material which conducts electricity or signals, e.g., copper or copper alloy. Although the conductor 20 is a solid wire having a circular cross section in the first embodiment, a solid wire having a cross section other than circle, such as rectangular, etc., may be used.

Structure of Grooved Insulation Layer

The grooved insulation layer 31 is in contact with the conductor 20 and has plural grooves 31a on the outer surface thereof. This allows the surface area of the outer periphery of the grooved insulation layer 31 to be increased as compared to the case of not forming the grooves 31a. Although the grooved insulation layer 31 is configured as a single layer in the first embodiment, two or more of multiple layers may be formed.

Although the groove 31a of the grooved insulation layer 31 is linearly formed along a direction parallel to an axial direction of the conductor 20 in the first embodiment, it may be formed in a direction inclined at a predetermined angle with respect to the axial direction of the conductor 20. The shape of the groove 31a extending along the axial direction of the conductor 20 may be a spiral or zigzag shape, etc., which extends in the axial direction. Alternatively, the groove 31a may have the shape linearly formed along a direction parallel to the axial direction of the conductor 20 to which a shape formed in a direction inclined at a predetermined angle with respect to the axial direction of the conductor 20 is added (e.g., a spiral shape).

Although the cross section of the groove 31a of the grooved insulation layer 31 in the first embodiment is in a semicircular shape in order to prevent the groove 31a from becoming an origin of cracks on the grooved insulation layer 31, it may be in a smoothly curved shape. In this regard, however, the groove 31a is not necessarily formed to have a smoothly curved cross section when the grooved insulation layer 31 has sufficient strength, and the cross sectional shape may be in other shapes such as, e.g., triangle or rectangle.

The number of the grooves 31a of the grooved insulation layer 31 may be one in order to increase the surface area of the outer periphery of the grooved insulation layer 31, however, the larger number of the grooves 31a is more preferable. In addition, an interval of the grooves 31a is not specifically limited. However, it is preferable to form the grooves 31a at equal intervals in light of uniform distribution of water.

Width and depth of the groove 31a are not specifically limited. However, regarding the depth of the groove 31a, the minimum thickness of the conventional insulation layer is determined by American Wire Gauge. Therefore, a thickness from an inner periphery of the grooved insulation layer 31 to a bottom portion of the groove 31a should be not less than the minimum thickness of the conventional insulation layer.

Structure of Sheath Layer

The sheath layer 40 has plural convex portions 40a on the inner periphery thereof so as to correspond to the plural grooves 31a of the grooved insulation layer 31, and the outer periphery of the sheath layer 40 is formed in a smoothly curved shape without unevenness. In addition, although the sheath layer 40 is a single layer in the first embodiment, two or more of multiple layers may be formed.

Materials of Grooved Insulation Layer and Sheath Layer

Both the grooved insulation layer 31 and the sheath layer 40 are preferably formed of a silane-crosslinked insulating resin composition, and are more preferably formed of a halogen-free flame-retardant thermoplastic composition. A resin or rubber as a main raw material is cross-linked with silane and is subsequently cured, thereby obtaining the halogen-free flame-retardant thermoplastic composition. It should be noted that use of the silane cross-linking method is a premise of the first embodiment, and the materials of the grooved insulation layer 31 and the sheath layer 40 are not intended to be specifically limited as long as it is possible to perform the silane cross-linking method.

Resin

Resin includes, e.g., polypropylene, high-density polyethylene, low-density polyethylene (LDPE), linear low-density polyethylene, ultra low density polyethylene, ethylene-butene-1 copolymer, ethylene-hexene-1 copolymer, ethylene-octene-1 copolymer, ethylene-vinyl acetate copolymer, ethylene-ethyl acrylate copolymer, polybutene, poly(4-methyl-pentene-1), ethylene-butene-hexene terpolymer, ethylene-methyl methacrylate copolymer, ethylene-methyl acrylate copolymer and ethylene-glycidyl methacrylate copolymer, etc. Two or more resins may be mixed and used.

Rubber

Rubber includes, e.g., ethylene-propylene-diene copolymer, ethylene-propylene copolymer, ethylene-butene-1 diene copolymer, ethylene-octene-1 diene copolymer, acrylonitrile butadiene rubber, acrylic rubber, styrene-diene copolymers as typified by styrene-butadiene rubber or styrene isoprene rubber, styrene-diene styrene copolymers as typified by styrene-butadiene-styrene rubber or styrene-isoprene-styrene rubber, and styrene-based rubber obtained by hydrogenation thereof. Two or more rubbers may be mixed and used.

Silane Compound

A silane compound which is graft-polymerized onto the resin or rubber as a main raw material is required to have a group capable of reacting with a polymer as well as an alkoxy group which forms cross-link by silanol condensation, as described below.

Examples of the silane compound include vinylsilane compounds such as vinyltrimethoxysilane, vinyltriethoxysilane and vinyl tris(β-methoxyethoxy)silane, etc., aminosilane compounds such as γ-aminopropyltrimethoxysilane, γ-aminopropyltriethoxysilane, N-(β-aminoethyl) γ-aminopropyltrimethoxysilane, (β-aminoethyl) γ-aminopropylmethyldimethoxysilane and N-phenyl-γ-aminopropyltrimethoxysilane, etc., epoxy-silane compounds such as β-(3,4-epoxycyclohexyl)ethyltrimethoxysilane and γ-glycidoxypropyltrimethoxysilane, γ-glycidoxypropylmethyldiethoxysilane, etc., acrylic silane compounds such as γ-methacryloxypropyltrimethoxysilane, etc., polysulfide silane compounds such as bis[3-(triethoxysilyl)propyl]disulfide, bis[3-(triethoxysilyl)propyl]tetrasulfide, etc., and mercapto silane compounds such as (3-mercaptopropyl)trimethoxysilane and (3-mercaptopropyl)triethoxysilane, etc.

Organic Peroxide

The followings are preferable organic peroxides to graft-polymerize the resin or rubber as a main raw material and the silane compound.

The organic peroxides include, e.g., dialkyl peroxides such as dicumyl peroxide, di-t-butyl peroxide, t-butyl cumyl peroxide, 2,5-dimethyl-2,5-di(t-butylperoxy)hexane, 2,5-dimethyl-2,5-di(t-butylperoxy) hexine-3 and 1,3-bis(t-butylperoxy-isopropyl)benzene, diacyl peroxides such as dimethylbenzoyl peroxide, and peroxy ketals such as n-butyl-4,4-bis(t-butylperoxy) valerate and 1,1-bis(t-butylperoxy)cyclohexane.

The added amount of the silane compound and that of the organic peroxide are not specifically limited. The added amount thereof can be appropriately determined depending on physical properties of a desired halogen-free flame-retardant thermoplastic composition.

Flame Retardant

Following metal hydroxides can be used as a flame retardant which is added to the halogen-free flame-retardant thermoplastic composition. The metal hydroxides include, e.g., magnesium hydroxide, aluminum hydroxide and calcium hydroxide, etc., and especially the magnesium hydroxide exhibits the highest flame retardant effect. The added amount of the flame retardant is not specifically limited, and can be appropriately determined depending on flame retardant properties of a desired halogen-free flame-retardant thermoplastic composition. In addition, it is preferable that the metal hydroxide be surface-treated in light of dispersibility.

Surface Treatment Agent

It is preferable that the following surface treatment agents be used for surface treatment of the metal hydroxide. The surface treatment agents include, e.g., a silane-based coupling agent, a titanate-based coupling agent and fatty acid or fatty acid metal salt, etc. Following silane-based coupling agents are specifically preferable in order to increase adhesion between the resin and the metal hydroxide.

The silane-based coupling agents include, e.g., vinylsilane compounds such as vinyltrimethoxysilane, vinyltriethoxysilane and vinyl tris(β-methoxyethoxy)silane, aminosilane compounds such as γ-aminopropyltrimethoxysilane, γ-aminopropyltriethoxysilane, N-(β-aminoethyl) γ-aminopropyltrimethoxysilane, (β-aminoethyl) γ-aminopropylmethyldimethoxysilane and N-phenyl-γ-aminopropyltrimethoxysilane, epoxy silane compounds such as β-(3,4-epoxycyclohexyl)ethyltrimethoxysilane, γ-glycidoxypropyltrimethoxysilane and γ-glycidoxypropylmethyldiethoxysilane, acrylic silane compounds such as γ-methacryloxypropyltrimethoxysilane, polysulfide silane compounds such as bis[3-(triethoxysilyl)propyl]disulfide and bis[3-(triethoxysilyl)propyl]tetrasulfide, and mercaptosilane compounds such as (3-mercaptopropyl)trimethoxysilane and (3-mercaptopropyl)triethoxysilane.

Silanol Condensation Catalyst

It is preferable to use the following silanol condensation catalysts as a catalyst which is mixed and kneaded after graft polymerization of main raw material.

The silanol condensation catalysts includes, e.g., dibutyltin dilaurate, dibutyltin diacetate, dibutyltin dioctoate, dioctyltin dilaurate, stannous acetate, stannous caprylate, zinc caprylate, lead naphthenate and cobalt naphthenate, etc.

In addition, the added amount of the catalyst depends on the type of catalyst. For the silanol condensation catalysts, the added amount is preferably set to 0.001 to 0.5 parts by mass per 100 parts by mass of silane compound.

The reason therefor is that, when the added amount of the silanol condensation catalyst is less than 0.001 parts by mass with respect to 100 parts by mass of silane compound, it is not possible to sufficiently function as a catalyst. On the other hand, when the added amount of the silanol condensation catalyst is more than 0.5 parts by mass with respect to 100 parts by mass of silane compound, scorching occurs in an extruder due to too fast reaction rate when the insulating resin composition is kneaded in the extruder and is coated on the conductor 20, which deteriorates an outer appearance of the grooved insulation layer 31 or the sheath layer 40.

As an addition method, a silanol condensation catalyst is added as-is. A method of using a masterbatch in which a silanol condensation catalyst is preliminarily mixed to a resin or rubber as a main raw material is also used.

Ultraviolet Absorber

It is possible to add an ultraviolet absorber to the insulating resin composition if needed. The ultraviolet absorber includes, e.g., a salicylic acid derivative, a benzophenone-based compound, a benzotriazole-based compound, an oxalic anilide derivative, 2-ethylhexyl-2-cyano-3,3-diphenylacrylate and compounds formed by a combination of two or more thereof.

In addition, the salicylic acid derivative includes, e.g., phenyl salicylate and p-tert-butyl phenyl salicylate.

The benzophenone-based compound includes, e.g., 2,4-dihydroxybenzophenone, 2-hydroxy-4-methoxybenzophenone, 2,2′-dihydroxy-4-methoxybenzophenone, 2,2′-dihydroxy-4,4′-dimethoxybenzophenone, 2-hydroxy-4-n-octoxy benzophenone, 2,2′,4,4′-tetrahydroxybenzophenone, 4-dodesiloxy-2-hydroxy-benzophenone, 3,5-di-tert-butyl-4-hydroxybenzoyl acid, n-hexadecyl ester, bis(5-benzoyl-4-hydroxy-2-methoxyphenyl)methane, 1,4-bis(4-benzoyl-3-hydroxyphenoxy)-butane and 1,6-bis(4-benzoyl-3-hydroxyphenoxy)hexane.

The benzotriazole-based compound includes, e.g., 2-(2′-hydroxy-5′-methylphenyl) benzotriazole, 2-(2′-hydroxy-3′,5′-di-tert-butylphenyl)benzotriazole, 2-(2′-hydroxy-3′-di-tert-butyl-5′-methylphenyl)-5-chlorobenzotriazole, 2-(2′-hydroxy-3′,5′-di-tert-butylphenyl)-5-chlorobenzotriazole, 2-(2′-hydroxy-5′-tert octylphenyl)benzotriazole, 2-(2′-hydroxy-3′,5′-di-tert amylphenyl)benzotriazole, 2,2′-methylenebis[4-(1,1,3,3-tetramethylbutyl)-6-(2H-benzotriazol-2-yl)phenol], 2-[2′-hydroxy-3′,5′-bis(α,α-dimethylbenzyl)-phenyl]-2H-benzotriazole and other benzotriazole derivatives.

Light Stabilizer

It is possible to add the following light stabilizers to the insulating resin composition if needed. The light stabilizer includes, e.g., a hindered amine light stabilizer.

The hindered amine light stabilizer includes, e.g., poly[[6-(1,1,3,3-tetramethylbutyl)imino-1,3,5-triazine-2,4-diyl][(2,2,6,6-tetramethyl-4-piperidyl)imino]hexamethylene[(2,2,6,6-tetramethyl-4-piperidyl)imino], poly[(6-morpholino-s-triazine-2,4-diyl)[2,2,6,6-tetramethyl-4-piperidyl)imino]-hexamethylene[(2,2,6,6-tetramethyl-4-piperidyl)imino]], N—N′-bis(3-aminopropyl)ethylenediamine-2,4-bis[N-butyl-N-(1,2,2,6,6-pentamethyl-4-piperidyl)amino]-6-chloro-1,3,5-triazine condensate, a polycondensate such as dibutylamine.1,3,5-triazine.N,N′-bis(2,2,6,6-tetramethyl-4-piperidyl-1,6-hexamethylenediamine.N-(2,2,6,6-tetramethyl-4-piperidyl)butylamine, or compounds formed by a combination of two or more thereof.

Other Additives

Besides the above mentioned substances, additives such as process oil, processing aid, flame-retardant aid, crosslinking aid, antioxidant, lubricant, inorganic filler, compatibilizing agent, stabilizer, carbon black and colorant can be added to the insulating resin composition if needed.

Manufacturing Method in the First Embodiment

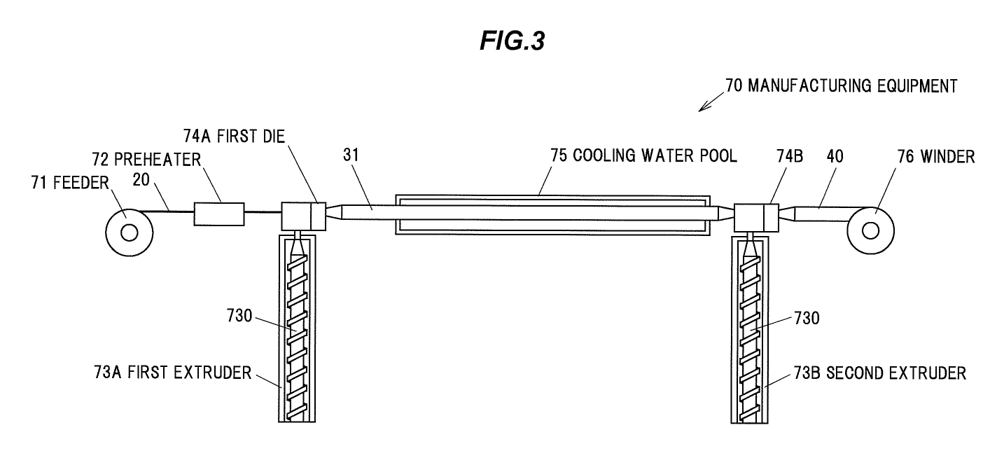

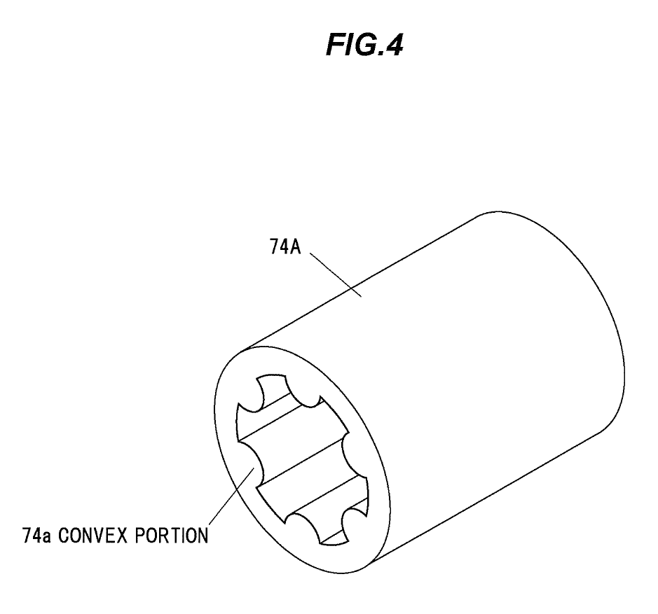

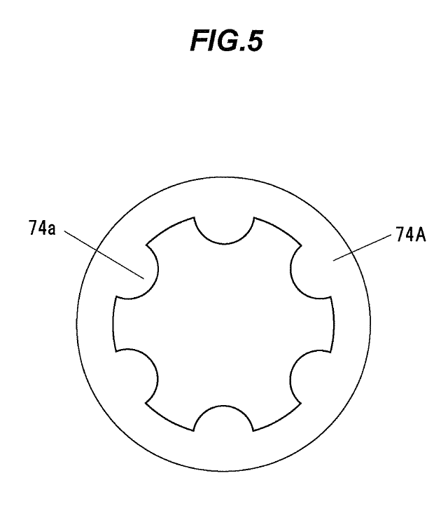

Next, an example of a method of manufacturing the coated wire 10 in the first embodiment will be described. FIG. 3 is a schematic diagram illustrating a configuration of a manufacturing system in the first embodiment. FIG. 4 is a perspective view showing an example of a die in the first embodiment and FIG. 5 is a front view showing the die shown in FIG. 4.

Manufacturing System

As shown in FIG. 3, a manufacturing system 70 in the first embodiment is schematically configured to have a feeder 71 for feeding the conductor 20, a preheater 72 for preheating the conductor 20 which is fed by the feeder 71, a first extruder 73A for extruding an insulating resin composition to coat the conductor 20, a first die 74A for shaping the insulating resin composition extruded from the first extruder 73A into the grooved insulation layer 31 on an outer periphery of the preheated conductor 20, a cooling water pool 75 adhering water on the outer periphery of the grooved insulation layer 31, a second extruder 73B for extruding the insulating resin composition to coat the grooved insulation layer 31, a second die 74B for shaping the insulating resin composition extruded from the second extruder 73B into the sheath layer 40 on an outer periphery of the grooved insulation layer 31 and a winder 76 for winding the coated wire 10 having the sheath layer 40 formed thereon.

The first die 74A shown in FIGS. 4 and 5 is arranged at an outlet port of the first extruder 73A. As shown in FIGS. 4 and 5, the first die 74A has convex portions 74a on an inner surface thereof (in general, a die is also called “mold” or “mouthpiece”).

The convex portion 74a is formed in a shape corresponding to the groove 31a of the grooved insulation layer 31 as shown in FIG. 5. Plural convex portions 74a in the same shape are provided here and are preferably arranged evenly at a certain angle around the center of the die. This is to provide geometric symmetry to the groove 31a of the grooved insulation layer 31 in light of strength at the time of bending the coated wire 10 and weight balance.

The typical second die 74B without convex portions which corresponds to the outer shape of the sheath layer 40 is arranged at an outlet port of the second extruder 73B.

The present manufacturing method includes at least a conductor feeding step, a grooved insulation layer forming step and a sheath layer forming step as shown in FIG. 3. In addition, it is preferable that the present manufacturing method include a conductor preheating step and a winding step.

(1) Conductor feeding step

In the conductor feeding step, the conductor 20 wound around a reel is fed by the feeder 71.

(2) Conductor preheating step

In the conductor preheating, the conductor 20 fed by the feeder 71 is preheated by the preheater 72.

(3) Grooved insulation layer forming step

The grooved insulation layer forming step includes an extrusion step and a silane cross-linking step. The frequency of performing the grooved insulation layer forming step depends on the number of the grooved insulation layers 31. Since the coated wire 10 in the first embodiment has a single grooved insulation layer 31, the grooved insulation layer forming step is performed once.

(3-1) Extrusion step

In the extrusion step, the insulating resin composition is extruded from the first extruder 73A by rotation of a screw 730 and is extrusion-formed on the outer periphery of the conductor 20 which is fed by the feeder 71. Since a groove processing method described below is used in this extrusion step, the grooves 31a shown in FIGS. 1 and 2 are formed on the outer periphery of the grooved insulation layer 31 along an axial direction of the conductor 20.

Groove Processing Method Using Die

When the insulating resin composition is extruded from the first extruder 73A through the outlet port, the convex portions 74a of the first die 74A blocks the flow of the insulating resin composition, and the grooves 31a along the convex portions 74a of the first die 74A are formed on the outer peripheral surface of the grooved insulation layer 31.

Groove Processing Method not Using Die

Various groove processing methods such as mechanical cutting or local melting by laser radiation after extrusion-forming the grooved insulation layer 31 can be selected. These various groove processing methods may be used alone or in combination with other groove processing methods including the groove processing method using a die.

(3-2) Water adhesion step

In the water adhesion step, the grooved insulation layer 31 is dipped in water in the cooling water pool 75 to adhere water to the outer periphery thereof. As a result, the water adhered on the surface of the grooved insulation layer 31 penetrates the insulating resin composition constituting the grooved insulation layer 31 and a hydrolysis reaction of the insulating resin composition gradually proceeds, thereby being silane cross-linked. As a water adhesion method, it is possible to use various methods such as dipping in water in the cooling water pool 75 as described above or natural adhesion using water contained in the air. Considering a cross-linking rate, dipping in the water in the cooling water pool 75 as described above is preferable as a water adhesion method.

(4) Sheath layer forming step

In the sheath layer forming step, the sheath layer 40 coating the grooved insulation layer 31 which coats the conductor 20 is formed. When the insulating resin composition is extruded from the second extruder 73B by rotation of the screw 730, the second die 74B shapes the insulating resin composition extruded from the second extruder 73B into the sheath layer 40 on the outer periphery of the grooved insulation layer 31.

The water adhesion method described above can be used for silane cross-linking of the sheath layer 40. Accordingly, in the first embodiment, the coated wire 10 is stored in the atmosphere after the following winding step to naturally adhere water in the air to the sheath layer 40 as the outermost layer of the coated wire 10, thereby naturally promoting silane cross-linking of the sheath layer 40.

(5) Winding step

After forming the sheath layer 40, the finished coated wire 10 is wound around a reel, etc., by the winder 76. The finished coated wire 10 is stored in a storage unit adjusted to a desired temperature and humidity, water in the air is naturally adhered to the surface of the sheath layer 40, etc., and penetrates inward, and the silane cross-linking is thereby promoted.

Effects of the First Embodiment

The following effects are obtained in the first embodiment.

(a) Since the surface area of the outer periphery of the grooved insulation layer 31 is increased by forming the groove 31a on the grooved insulation layer 31 and the surface absorption and internal penetration amount of water required for cross-linking is thus increased, cross-linking of the grooved insulation layer 31 is promoted and it is possible to realize shorter cross-linking time.

When the surface area of the outer peripheral surface of the grooved insulation layer 31 is increased by, e.g., about 30%, the surface absorption amount of water is also increased by 30%. It is possible to hydrolyze alkoxysilane contained in the insulating resin composition by the water, leading to the subsequent dehydration condensation. Based on the theoretical formula, it is necessary to hydrolyze at least two alkoxysilanes in order to obtain a water molecule by dehydration condensation. Therefore, a countermeasure of increasing the initial surface absorption amount is effective in light of improvement in the cross-linking rate.

In addition, when the surface absorption amount of the grooved insulation layer 31 is increased, water is likely to be dispersed inside the grooved insulation layer 31 based on Fick's law. Accordingly, the amount of internal penetration of the grooved insulation layer 31 is increased and hydrolysis of alkoxysilane inside the grooved insulation layer 31 thus proceeds.

Note that, under present circumstances, it is not necessary to accelerate the cross-linking rate even by making a groove on a surface since the sheath layer 40 is exposed to the air for long time. That is, the outer appearance of the coated wire 10 does not change from the conventional art and there is no change in handling of the coated wire 10, hence, users of the coated wire 10 do not have storage obligation beyond the conventional art.

(b) By forming the grooves 31a on the grooved insulation layer 31, the convex portions 40a of the sheath layer 40 which protrude corresponding to the grooves 31a are engaged with the grooves 31a. The engagement generates an anchor effect and it is thus possible to improve adhesion of the grooved insulation layer 31 to the sheath layer 40.

(c) Since the grooved insulation layer 31 is formed by extrusion using a die, it is possible to eliminate the step of forming grooves such as mechanical cutting and the coated wire 10 in the first embodiment can be manufactured with manufacturing burden which is not much different from the conventional manufacturing method.

### Second Embodiment

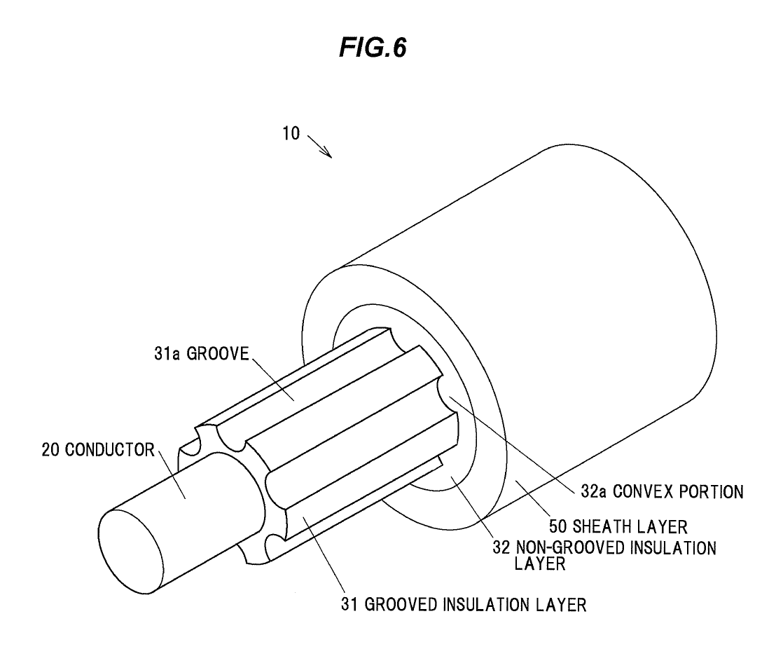

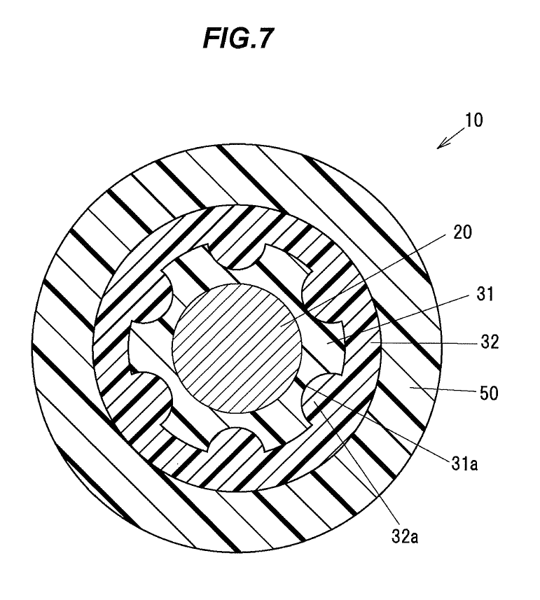

FIG. 6 is an exploded perspective view showing a coated wire in a second embodiment of the invention and FIG. 7 is a cross sectional view showing the coated wire shown in FIG. 6. The second embodiment is different from the first embodiment in that a non-grooved insulation layer 32 is formed between the grooved insulation layer 31 and the sheath layer, and the rest of the configuration is the same as the first embodiment. In other words, the coated wire 10 in the second embodiment has the conductor 20, the grooved insulation layer 31 coating the conductor 20, the non-grooved insulation layer 32 coating the grooved insulation layer 31 and a sheath layer 50 coating the non-grooved insulation layer 32. The grooved insulation layer 31, the non-grooved insulation layer 32 and the sheath layer 50 are examples of a coating layer.

The non-grooved insulation layer 32 is interposed between the grooved insulation layer 31 and the sheath layer 50. The non-grooved insulation layer 32 has, on an inner periphery thereof, plural convex portions 32a corresponding to the plural grooves 31a of the grooved insulation layer 31, and is formed to have an outer periphery in a smoothly curved shape without unevenness. In addition, although a single non-grooved insulation layer 32 is formed in the second embodiment, two or more of multiple layers may be formed.

Similarly to the grooved insulation layer 31, the non-grooved insulation layer 32 is preferably formed of a silane-crosslinked insulating resin composition, and is more preferably formed of a halogen-free flame-retardant thermoplastic composition.

The sheath layer 50 is formed to have an inner periphery in a smoothly curved shape without unevenness and an outer periphery also in a smoothly curved shape without unevenness. In addition, although a single sheath layer 50 is formed in the second embodiment, two or more of multiple layers may be formed. Similarly to the grooved insulation layer 31, the sheath layer 50 is preferably formed of a silane-crosslinked insulating resin composition, and is more preferably formed of a halogen-free flame-retardant thermoplastic composition.

Manufacturing Method in the Second Embodiment

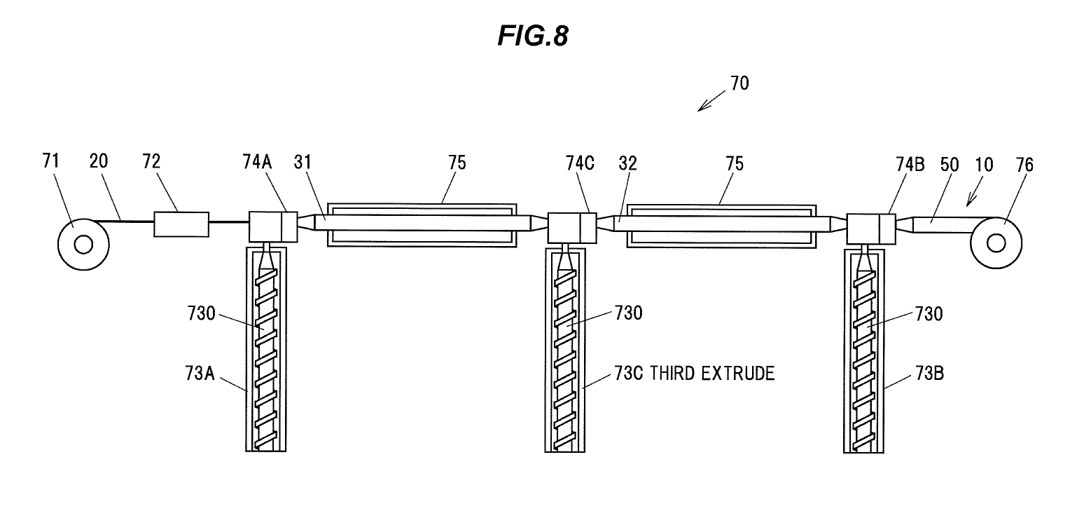

Next, an example of a method of manufacturing the coated wire in the second embodiment will be described. FIG. 8 is a schematic diagram illustrating a configuration of a manufacturing system in the second embodiment.

The manufacturing system 70 in the second embodiment is different from the manufacturing system 70 in the first embodiment in that a third extruder 73C and a cooling water pool 75 are arranged between the first extruder 73A and the second extruder 73B as shown in FIG. 8, and the rest of the configuration is the same as the manufacturing system 70 in the first embodiment.

The third extruder 73C is for forming the non-grooved insulation layer 32 on the outer periphery of the grooved insulation layer 31 and a typical third die 74C having convex portions on an inner periphery thereof so as to correspond to the outer shape of the non-grooved insulation layer 32 is arranged at an outlet port of the third extruder 73C.

The second embodiment includes (1) Conductor feeding step, (2) Conductor preheating step, (3) Grooved insulation layer forming step, (4) Non-grooved insulation layer forming step, (5) Sheath layer forming step and (6) Winding step. (1) Conductor feeding step, (2) Conductor preheating step, (3) Grooved insulation layer forming step, (5) Sheath layer forming step and (6) Winding step are the same as the first embodiment and the explanations thereof will be omitted.

The grooved insulation layer 31 is formed on the outer periphery of the conductor 20 by performing (1) Conductor feeding step, (2) Conductor preheating step and (3) Grooved insulation layer forming step in the same manner as the first embodiment.

(4) Non-grooved insulation layer forming step

The subsequent non-grooved insulation layer forming step includes the extrusion step and the water adhesion step. The frequency of performing the non-grooved insulation layer forming step depends on the number of the non-grooved insulation layers 32. Since a single non-grooved insulation layer 32 is formed in the second embodiment, the non-grooved insulation layer forming step is performed once.

(4-1) Extrusion step

In the extrusion step, when the insulating resin composition is extruded from the third extruder 73C by rotation of the screw 730, the third die 74C shapes the insulating resin composition extruded from the third extruder 73C into the non-grooved insulation layer 32 on the outer periphery of the grooved insulation layer 31.

(4-2) Water adhesion step

In the water adhesion step, water is adhered to the outer periphery of the non-grooved insulation layer 32 by dipping, etc., the non-grooved insulation layer 32 in water in the cooling water pool 75 as shown in FIG. 8, the water inwardly penetrates the non-grooved insulation layer 32, a hydrolysis reaction of the composition constituting the non-grooved insulation layer 32 proceeds and the composition is being silane cross-linked.

After that, (5) Sheath layer forming step and (6) Winding step are performed in the same manner as the first embodiment.

Effects of the Second Embodiment

In the second embodiment, the following effects are obtained in addition to the effects of the first embodiment.

(a) Since two insulation layers which are the grooved insulation layer 31 and the non-grooved insulation layer 32 laminated in this order are arranged between the conductor 20 and the sheath layer 50, it is possible to promptly coat the non-grooved insulation layer 32 and the sheath layer 50 while promoting the cross-linking of the grooved insulation layer 31 which is arranged inward and it is thus possible to reduce the total time required for manufacturing.

(b) Since the minimum thickness of the insulation layer determined by American Wire Gauge is satisfied by the total thickness of the grooved insulation layer 31 and the non-grooved insulation layer 32, the thickness of the grooved insulation layer 31 from the inner periphery thereof to the bottom of the groove 31a can be not greater than the minimum thickness of the conventional insulation layer.

Modification of the Second Embodiment

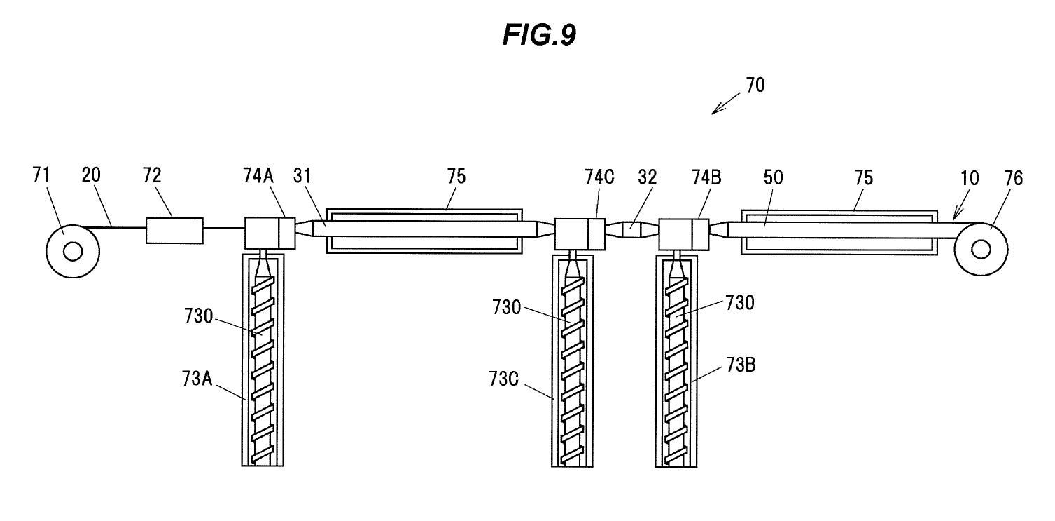

FIG. 9 is a schematic diagram illustrating a configuration of a manufacturing system in a modification of the second embodiment. In the manufacturing system 70 of the modification, the cooling water pool 75 which is located between the third extruder 73C and the second extruder 73B in the manufacturing system 70 shown in FIG. 8 is moved posterior to the second extruder 73B, and the rest of the configuration is the same as the manufacturing system 70 shown in FIG. 8. In other words, in the manufacturing process by this manufacturing system 70, the sheath layer 50 is formed immediately after forming the non-grooved insulation layer 32 and the water adhesion step is subsequently performed at one time.

(4-1) Extrusion step

In the extrusion step, the non-grooved insulation layer 32 is formed on the outer periphery of the grooved insulation layer 31 by the third extruder 73C and the third die 74C in the same manner as FIG. 8. Subsequently, the sheath layer 50 is formed on the outer periphery of the non-grooved insulation layer 32 by the second extruder 73B and the second die 74B.

(4-2) Water adhesion step

In the water adhesion step, water is adhered to the outer periphery of the sheath layer 50 by dipping, etc., in water in the cooling water pool 75 after the sheath forming step, as shown in FIG. 9.

Here, water adhered to the outer periphery of the grooved insulation layer 31 is supplied to the inner periphery of the non-grooved insulation layer 32 and water penetrating inward from the outer periphery of the sheath layer 50 is supplied to the outer periphery of the non-grooved insulation layer 32. As a result, the water adhered to the grooved insulation layer 31 and the sheath layer 50 is supplied to the non-grooved insulation layer 32, and then, the grooved insulation layer 31, the non-grooved insulation layer 32 and the sheath layer 50 are cross-linked.

Although the sheath layer 50 is extrusion-formed after extrusion-forming the non-grooved insulation layer 32 in the modification of the second embodiment, it is possible to adopt an extrusion step of simultaneously forming the non-grooved insulation layer 32 and the sheath layer 50 when the step as shown in FIG. 9 is used.

Effects of the Modification of the Second Embodiment

According to the modification shown in FIG. 9, since water is adhered to the non-grooved insulation layer 32 by the water adhesion step for the grooved insulation layer 31 located inside the non-grooved insulation layer 32 and that for the sheath layer 50 located outside the non-grooved insulation layer 32, it is possible to reduce one water adhesion step.

### Third Embodiment

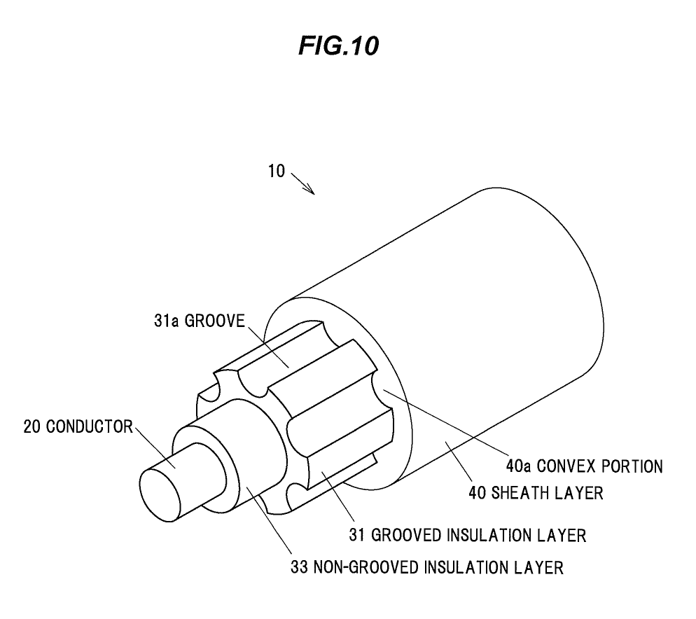

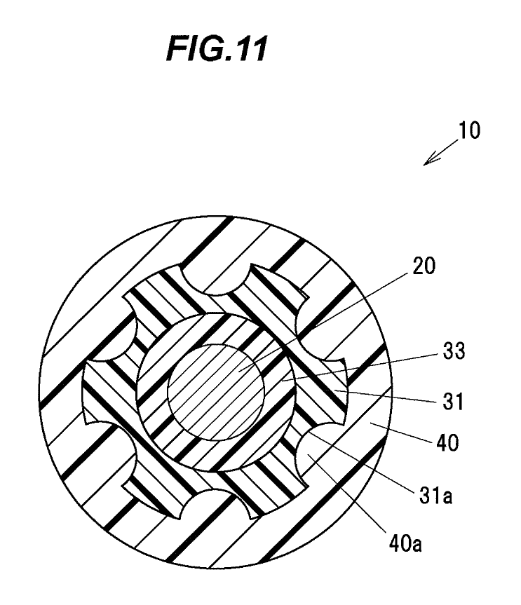

FIG. 10 is an exploded perspective view showing a coated wire in a third embodiment of the invention and FIG. 11 is a cross sectional view showing the coated wire shown in FIG. 10. The third embodiment is different from the first embodiment in that a non-grooved insulation layer 33 is formed between the conductor 20 and the grooved insulation layer 31, and the rest of the configuration is the same as the first embodiment. In other words, the coated wire 10 in the third embodiment has the conductor 20, the non-grooved insulation layer 33 coating the conductor 20, the grooved insulation layer 31 coating the non-grooved insulation layer 33 and the sheath layer 40 coating the grooved insulation layer 31. The non-grooved insulation layer 33, the grooved insulation layer 31 and the sheath layer 40 are examples of a coating layer.

The non-grooved insulation layer 33 is formed to have inner and outer peripheries which have a smoothly curved shape without unevenness. In addition, although a single non-grooved insulation layer 33 is formed in the third embodiment, two or more of multiple layers may be formed.

Similarly to the grooved insulation layer 31, the non-grooved insulation layer 33 is preferably formed of a silane-crosslinked insulating resin composition, and is more preferably formed of a halogen-free flame-retardant thermoplastic composition.

Manufacturing Method in the Third Embodiment

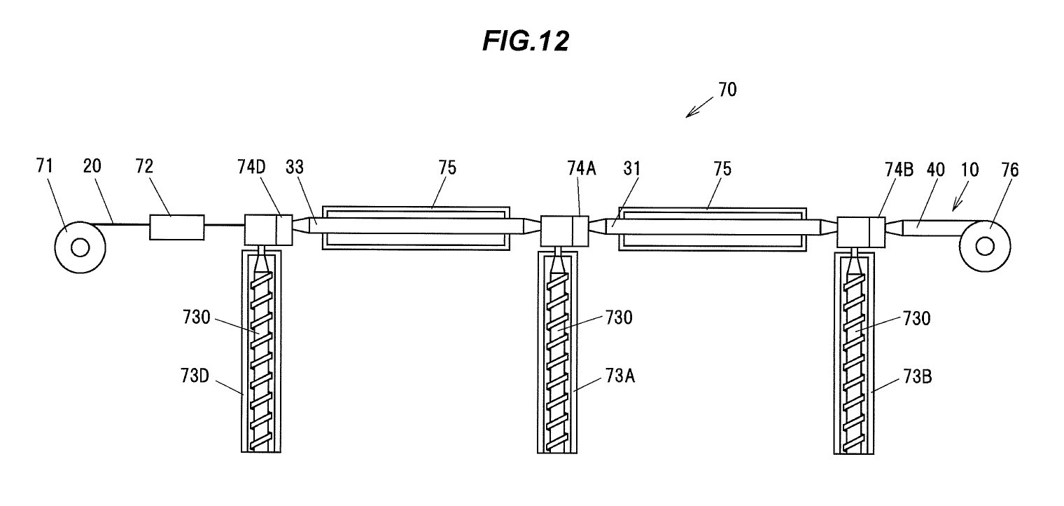

Next, an example of a method of manufacturing the coated wire in the third embodiment will be described. FIG. 12 is a schematic diagram illustrating a configuration of a manufacturing system in the third embodiment.

As shown in FIG. 12, the manufacturing system 70 in the third embodiment is different from the manufacturing system 70 in the first embodiment shown in FIG. 3 in that a fourth extruder 73D and a cooling water pool 75 are arrange anterior to the first extruder 73A, and the rest of the configuration is the same as the first embodiment.

The fourth extruder 73D is for forming the non-grooved insulation layer 33 on the outer periphery of the conductor 20 and a typical fourth die 74D having convex portions on an inner surface thereof so as to correspond to the outer shape of the non-grooved insulation layer 33 is arranged at an outlet port of the fourth extruder 73D.

As shown in FIG. 12, the third embodiment includes (1) Conductor feeding step, (2) Conductor preheating step, (3) Non-grooved insulation layer forming step, (4) Grooved insulation layer forming step, (5) Sheath layer forming step and (6) Winding step. (1) Conductor feeding step, (2) Conductor preheating step, (4) Grooved insulation layer forming step, (5) Sheath layer forming step and (6) Winding step are the same as the first embodiment and the explanations thereof will be omitted.

(3) Non-grooved insulation layer forming step

The non-grooved insulation layer forming step includes the extrusion step and the water adhesion step. The frequency of performing the non-grooved insulation layer forming step depends on the number of the non-grooved insulation layers 33. Since a single non-grooved insulation layer 33 is formed in the third embodiment, the non-grooved insulation layer forming step is performed once.

(3-1) Extrusion step

The insulating resin composition is extruded by rotation of the screw 730 and is extrusion-formed as the non-grooved insulation layer 33 on the outer periphery of the conductor 20 which is fed by the feeder 71.

(3-2) Water adhesion step

In the water adhesion step, as shown in FIG. 12, dipping in water in the cooling water pool 75, etc., is carried out before forming the grooved insulation layer 31 and is then repeated again after forming the grooved insulation layer 31. It is possible to adhere sufficient water for causing hydrolysis by respectively performing the water adhesion steps after extrusion-forming the non-grooved insulation layer 33 and after extrusion-forming the grooved insulation layer 31.

Effects of the Third Embodiment

In the third embodiment, the following effects are obtained in addition to the effects of the first embodiment.

(a) Since the grooved insulation layer 31 is arranged between the non-grooved insulation layer 33 and the sheath layer 40, it is possible to promptly coat the sheath layer 40 while promoting the cross-linking of the grooved insulation layer 31 and it is thus possible to reduce the total time required for manufacturing.

(b) Since the insulation layer is composed of two layers which are the non-grooved insulation layer 33 and the grooved insulation layer 31, the thickness of the grooved insulation layer 31 from the inner periphery thereof to the bottom of the groove 31a can be not greater than the minimum thickness of the conventional insulation layer.

Modification of the Third Embodiment

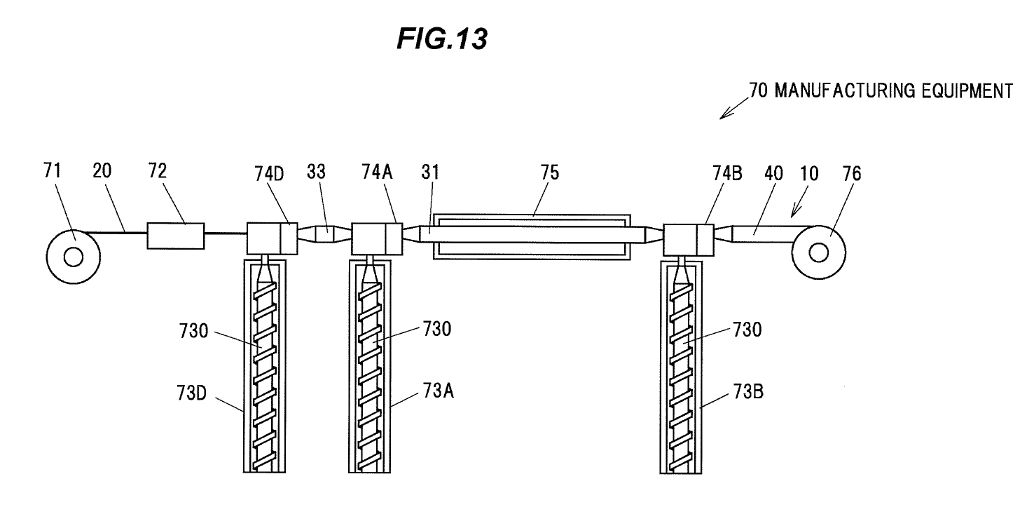

FIG. 13 is a schematic diagram illustrating a configuration of a manufacturing system in a modification of the third embodiment. In the manufacturing system 70 of this modification, the cooling water pool 75 which is located between the fourth extruder 73D and the first extruder 73A in the manufacturing system 70 shown in FIG. 12 is omitted and the rest of the configuration is the same as the manufacturing system 70 shown in FIG. 12.

The non-grooved insulation layer 33 is formed on the outer periphery of the conductor 20, the grooved insulation layer 31 is formed on the outer periphery of the non-grooved insulation layer 33, and then, the water adhesion step is performed. Here, water which penetrates inward from the outer periphery of the grooved insulation layer 31 is also supplied to the outer periphery of the non-grooved insulation layer 33, and the cross-linking of the non-grooved insulation layer 33 is also promoted.

Although the grooved insulation layer 31 is extrusion-formed after extrusion-forming the non-grooved insulation layer 33 in the modification of the third embodiment, it is possible to adopt an extrusion step of simultaneously forming the grooved insulation layer 31 and the non-grooved insulation layer 33 when the step as shown in FIG. 13 is used.

Effects of the Modification of the Third Embodiment

According to the modification shown in FIG. 13, since the water adhesion step for the grooved insulation layer 31 also serves to adhere water to the non-grooved insulation layer 33, it is possible to reduce one water adhesion step.

### Fourth Embodiment

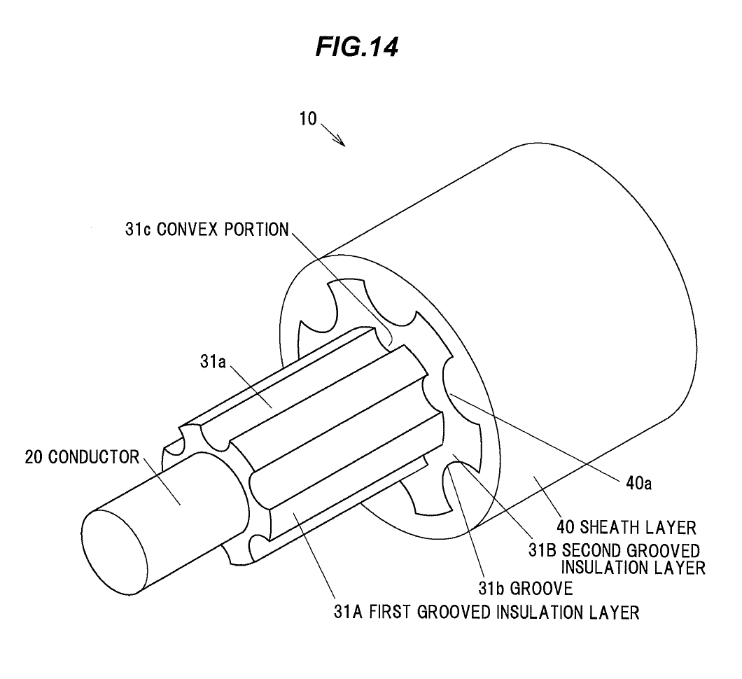

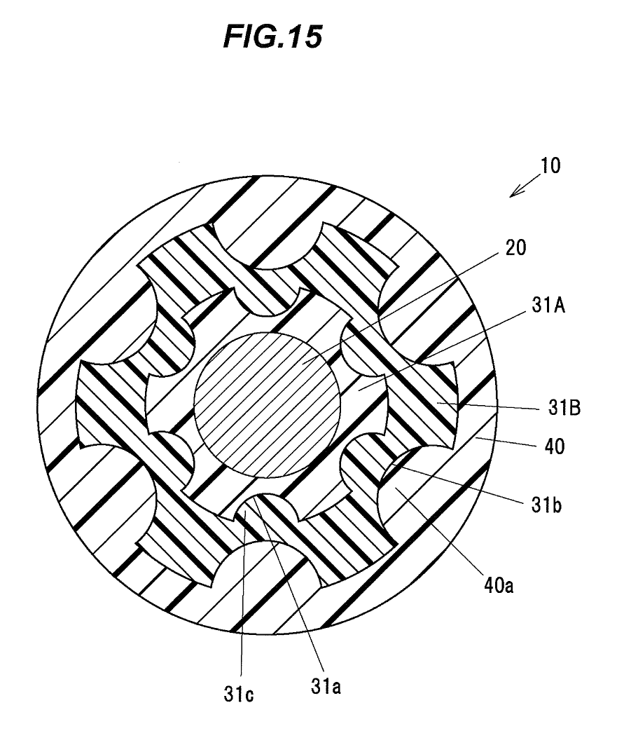

FIG. 14 is an exploded perspective view showing a coated wire in a fourth embodiment of the invention and FIG. 15 is a cross sectional view showing the coated wire shown in FIG. 14. The grooved insulation layer 31 which is composed of a single layer in the first embodiment is composed of two layers of first and second grooved insulation layers 31A and 31B in the fourth embodiment, and the rest of the configuration is the same as the first embodiment. In other words, the coated wire 10 in the fourth embodiment has the conductor 20, the first grooved insulation layer 31A coating the conductor 20, the second grooved insulation layer 31B coating the first grooved insulation layer 31A and the sheath layer 40 coating the second grooved insulation layer 31B. The first grooved insulation layer 31A, the second grooved insulation layer 31B and the sheath layer 40 are examples of a coating layer.

The first grooved insulation layer 31A is in contact with the conductor 20 and has plural grooves 31a on the outer periphery thereof in the same manner as the grooved insulation layer 31 of the first embodiment.

The second grooved insulation layer 31B has plural convex portions 31c on the inner periphery thereof so as to correspond to the plural grooves 31a of the first grooved insulation layer 31A and also has plural grooves 31b on the outer periphery thereof.

Similarly to the grooved insulation layer 31 in the first embodiment, the first and second grooved insulation layers 31A and 31B are preferably formed of a silane-crosslinked insulating resin composition, and are more preferably formed of a halogen-free flame-retardant thermoplastic composition. In addition, although two grooved insulation layers 31A and 31B are formed in the fourth embodiment, three or more of multiple layers may be formed.

Manufacturing Method in the Fourth Embodiment

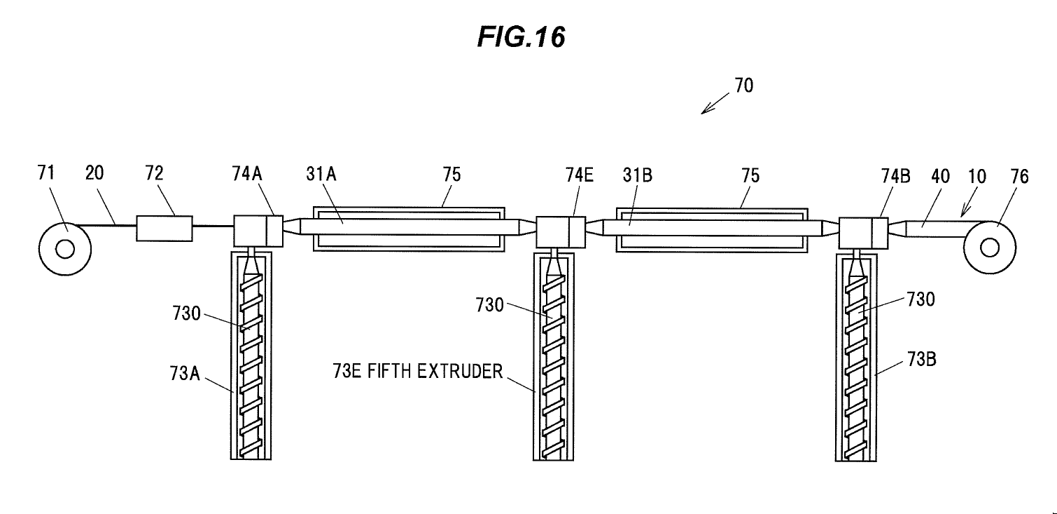

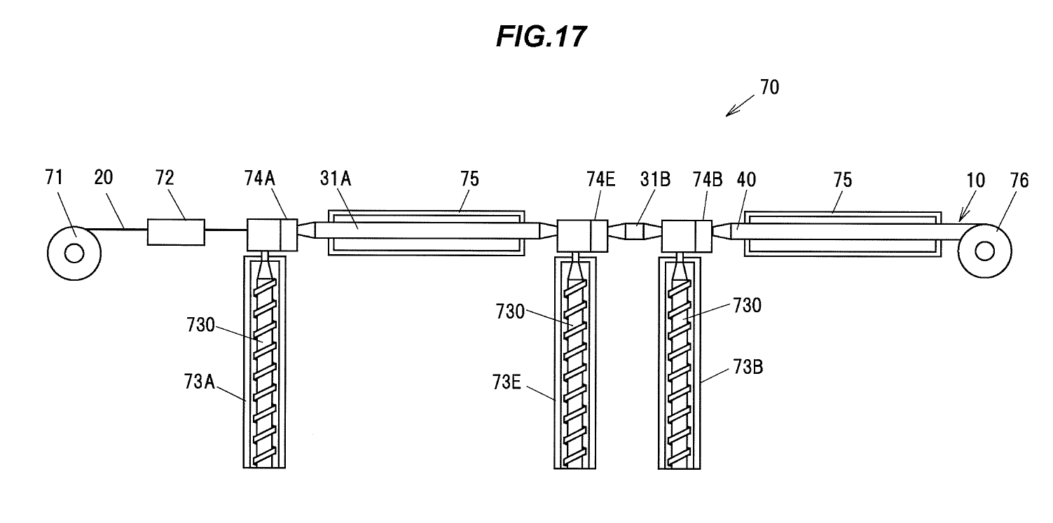

Next, an example of a method of manufacturing the coated wire 10 in the fourth embodiment will be described. FIG. 16 is a schematic diagram illustrating a configuration of a manufacturing system in the fourth embodiment. FIG. 17 is a schematic diagram illustrating a configuration of a manufacturing system for the coated wire 10 in a modification of the fourth embodiment.

As shown in FIG. 16, the manufacturing system 70 in the fourth embodiment is different from the manufacturing system 70 in the first embodiment shown in FIG. 3 in that a fifth extruder 73E and a cooling water pool 75 are arranged between the first extruder 73A and the second extruder 73B.

The first die 74A shown in FIGS. 4 and 5 is arranged at an outlet port of the first extruder 73A. The first die 74A has the convex portions 74a on the inner periphery thereof so as to correspond to the grooves 31a of the first grooved insulation layer 31A.

A fifth die 74E is arranged at an outlet port of the fifth extruder 73E. The fifth die 74E has convex portions on the inner periphery thereof so as to correspond to the grooves 31b of the second grooved insulation layer 31B.

As shown in FIG. 16, the fourth embodiment includes (1) Conductor feeding step, (2) Conductor preheating step, (3) Grooved insulation layer forming step, (4) Sheath layer forming step and (5) Winding step. (1) Conductor feeding step, (2) Conductor preheating step, (4) Sheath layer forming step and (5) Winding step are the same as the first embodiment and the explanations thereof will be omitted.

(3) Grooved insulation layer forming step

The grooved insulation layer forming step includes the extrusion step and the silane cross-linking step in the same manner as the first embodiment. The frequency of performing the grooved insulation layer forming step depends on the number of the grooved insulation layers 31. The grooved insulation layer forming step is performed twice in the fourth embodiment since the grooved insulation layer 31 has a two-layer structure composed of the first grooved insulation layer 31A located inner side and the second grooved insulation layer 31B located outer side.

(3-1) Extrusion step for First grooved insulation layer 31A

In the extrusion step for the first grooved insulation layer 31A, as shown in FIG. 16, the insulating resin composition is extruded from the first extruder 73A and the first grooved insulation layer 31A is thus extrusion-formed on the outer periphery of the conductor 20 which is fed by the feeder 71. Since the first die 74A having the convex portions 74a on the inner periphery thereof is arranged at the outlet port of the first extruder 73A, the grooves 31a are formed on the outer periphery of the first grooved insulation layer 31A.

(3-2) Water adhesion step for First grooved insulation layer 31A

In the water adhesion step for the first grooved insulation layer 31A, as shown in FIG. 16, water is adhered to the outer periphery of the first grooved insulation layer 31A by dipping, etc., in water in the cooling water pool 75 after the extrusion step for the first grooved insulation layer 31A and before the extrusion step for the second grooved insulation layer 31B, and water which is sufficient to hydrolyze the first grooved insulation layer 31A is adhered to the surface to promote the silane cross-linking.

(3-3) Extrusion step for Second grooved insulation layer 31B

In the extrusion step for the second grooved insulation layer 31B, the insulating resin composition is extruded from the fifth extruder 73E and the second grooved insulation layer 31B is thus extrusion-formed on the outer periphery of the first grooved insulation layer 31A. Since the fifth die 74E having the convex portions on the inner periphery thereof is arranged at the outlet port of the fifth extruder 73E, the grooves 31b are formed on the outer periphery of the second grooved insulation layer 31B.

(3-4) Water adhesion step for Second grooved insulation layer 31B

In the water adhesion step, as shown in FIG. 16, water is adhered to the outer periphery of the second grooved insulation layer 31B by dipping, etc., in water in the cooling water pool 75 after forming the second grooved insulation layer 31B and before the sheath layer forming step, and water which is sufficient to hydrolyze the second grooved insulation layer 31B is adhered to the surface to promote the silane cross-linking.

Effects of the Fourth Embodiment

In the fourth embodiment, the following effects are obtained in addition to the effects of the first embodiment.

(a) Since the two grooved insulation layers 31A and 31B are arranged between the conductor 20 and the sheath layer 40, it is possible to promptly coat the sheath layer 40 while promoting the cross-linking of the two grooved insulation layers 31A and 31B and it is thus possible to reduce the total time required for manufacturing.

(b) By forming the grooved insulation layers 31A and 31B, the convex portions 31c of the second grooved insulation layer 31B which protrude corresponding to the grooves 31a are engaged with the grooves 31a and the convex portions 40a of the sheath layer 40 which protrude corresponding to the grooves 31b are engaged with the grooves 31b. Therefore, good adhesion between coating layers composed of the grooved insulation layers 31A, 31B and the sheath layer 40 is obtained.

Modification of the Fourth Embodiment

FIG. 17 is a schematic diagram illustrating a configuration of a manufacturing system in a modification of the fourth embodiment. In the manufacturing system 70 of this modification, the cooling water pool 75 which is located between the fifth extruder 73E and the second extruder 73B is moved posterior to the second extruder 73B.

(3-4) Water adhesion step for Second grooved insulation layer 31B

As shown in FIG. 17, the step of dipping, etc., in water in the cooling water pool 75 after forming the second grooved insulation layer 31B and before the sheath layer forming step shown in FIG. 16 is omitted and the water adhesion step for the second grooved insulation layer 31B and that for the sheath layer 40 are performed at a time.

Here, the water adhered to the outer periphery of the first grooved insulation layer 31A is supplied to the inner periphery of the second grooved insulation layer 31B and the water penetrating inward from the outer periphery of the sheath layer 40 is supplied to the outer periphery of the second grooved insulation layer 31B.

Although the sheath layer 40 is extrusion-formed after extrusion-forming the second grooved insulation layer 31B in the modification of the fourth embodiment, it is possible to adopt an extrusion step of simultaneously forming the second grooved insulation layer 31B and the sheath layer 40 when the step as shown in FIG. 17 is used.

Effects of the Modification of the Fourth Embodiment

According to this modification, since the water adhesion step for the sheath layer 40 also serves to adhere water to the second grooved insulation layer 31B, it is possible to reduce one water adhesion step.

### Fifth Embodiment

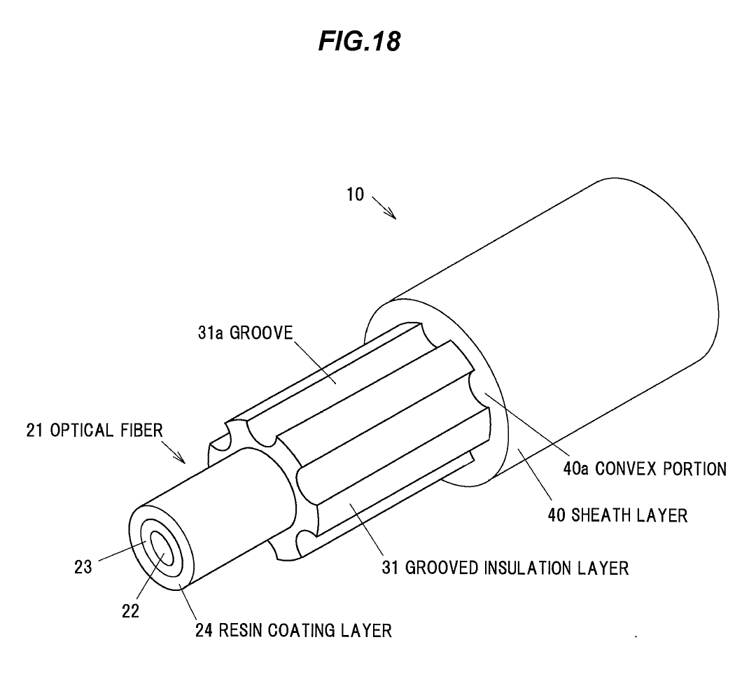

FIG. 18 is an exploded perspective view showing a coated wire in a fifth embodiment of the invention. This coated wire 10 is an optical fiber cable having an optical fiber 21, the grooved insulation layer 31 coating the optical fiber 21 and the sheath layer 40 coating the grooved insulation layer 31. The optical fiber 21 is an example of a core wire and is provided with a core 22 for conducting optical signals, a cladding 23 formed around the core 22 and a coating layer 24 formed of a resin.

The coated wire 10 in the fifth embodiment can be manufactured in the same manner as the first embodiment. In addition, the structures of the coating layer in the second to fourth embodiments can be adopted for the fifth embodiment. Alternatively, it is possible to use plural optical fibers which are collectively coated with a resin or which are inserted into a tube, or a linear or columnar body having grooves to accommodate optical fibers may be used together. In addition, an intervening layer may be provided between the fiber and the insulation layer 31.

Coated wires in Examples and Comparative Examples as a further specific embodiment of the invention will be described in detail below in reference to Tables 1 to 10. Only typical examples of coated wires of the invention are cited in Examples and the invention is not limited thereto.

### Example 1

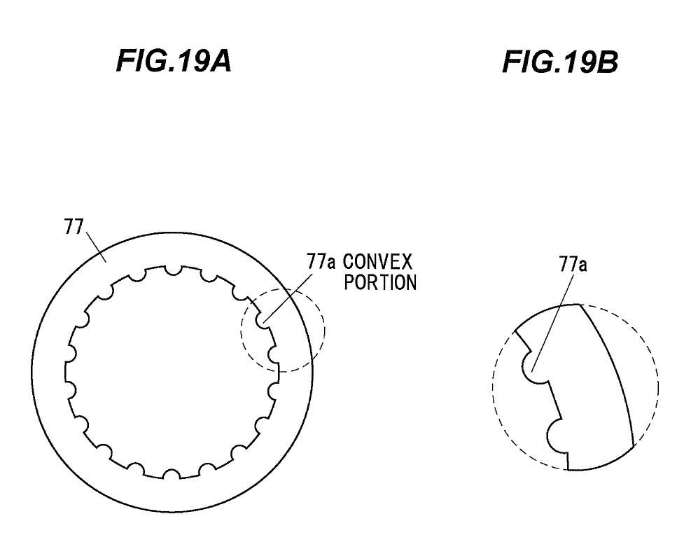

A coated wire in Example 1 corresponds to the first embodiment. FIG. 19A is a front view showing a die used in an extrusion step for a grooved insulation layer in Example 1 and FIG. 19B is an enlarged view showing a convex portion of the die. A die 77 shown in FIGS. 19A and 19B has eighteen convex portions 77a on an inner periphery thereof and the maximum inner diameter (of a portion without the convex portion 77a) is 13 mm. The convex portion 77a has a hemispherical shape. The diameter of the convex portion 77a is about 1.14 mm and the height thereof is 0.57 mm which is the half of the diameter. In addition, the eighteen convex portions 77a are arranged evenly for every 10 degrees around the center of the die 77. The arrangement interval of the convex portions 77a is about 1.14 mm, which is the same as the diameter.

In the coated wire of Example 1, a copper wire with a circular cross section having a nominal cross-sectional area of 60 mm² and an outer diameter of 9.2 mm was used as the conductor 20, the grooved insulation layer 31 was then formed on the outer periphery of the conductor 20 and the sheath layer 40 was formed on the outer periphery of the grooved insulation layer 31 so that the outer diameter of the coated wire is 16.0 mm. The total thickness of the grooved insulation layer 31 and the sheath layer 40 was 3.4 mm. The maximum thickness of the grooved insulation layer 31 is 1.9 mm and the minimum thickness of the sheath layer 40 (a thickness of a portion on which the convex portion 40a is not formed) was 1.5 mm.

A surface area of an outer periphery of a grooved insulation layer in Example 1 was enlarged by about 28.5% compared to that of a non-grooved insulation layer having an outer diameter equivalent to that of the grooved insulation layer. After forming a sheath layer, the coated wire in Example 1 was stored in a storage unit adjusted to room temperature and humidity of 50%.

### Example 2

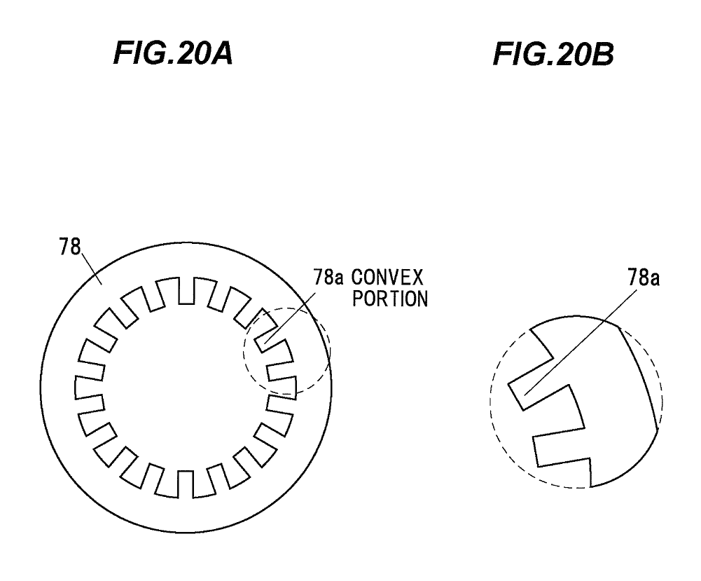

FIG. 20A is a front view showing a first die used in an extrusion step for a grooved insulation layer in Example 2 and FIG. 20B is an enlarged view showing a convex portion of the first die. Similarly to Example 1, the minimum inner diameter of a die 78 shown in FIGS. 20A and 20B is 13 mm. A convex portion 78a has a rectangular shape. The convex portion 78a has a width of about 0.3 mm and a height of 0.5 mm. In addition, the eighteen convex portions 78a are arranged evenly for every 10 degrees around the center of the die 78. The arrangement interval of the convex portions 78a is about 0.94 mm.

In Example 2, a circumference of a non-grooved insulation layer having a constant outer diameter without grooves was 40.8 mm while that of a grooved insulation layer was 56.8 mm which is 1.44 times of the non-grooved insulation layer. As a result, the surface area of the outer periphery of the grooved insulation layer was enlarged by about 44% compared to that of the non-grooved insulation layer.

After forming a sheath layer, the coated wire in Example 2 was stored in a storage unit adjusted to room temperature and humidity of 50%.

### Example 3

A coated wire in Example 3 was manufactured under the same conditions as the coated wire in Example 1 except a difference in a storing condition. After forming a sheath layer of the coated wire in Example 3, it was stored in a storage unit adjusted to a temperature of 70° C. and humidity of 50%.

### Comparative Example 1

In a coated wire in Comparative Example 1, the same wire as Example 1 was used as the conductor 20, a 1.9 mm-thick non-grooved insulation layer was then formed on the outer periphery of the conductor 20 and a 1.5 mm-thick sheath layer was formed on the outer periphery of the non-grooved insulation layer. After forming the sheath layer, the coated wire in Comparative Example 1 was stored in a storage unit adjusted to room temperature and humidity of 50%.

### Comparative Example 2

A coated wire in Comparative Example 2 has the same configuration as that of Comparative Example 1 except a difference in a storing condition. After forming a sheath layer, the coated wire in Comparative Example 2 was stored in a thermostatic chamber adjusted to a temperature of 70° C. and humidity of 95%.

The coated wires in Examples 1, 2, 3 and Comparative Examples 1 and 2 were stored in a storage unit or thermostatic chamber adjusted to the temperatures and humidities described above after forming the sheath layer, and variations in gel fraction and hot-set of the grooved and non-grooved insulation layers were examined over storage time.

The same halogen-free flame-retardant thermoplastic composition was used for all of the grooved insulation layer, the non-grooved insulation layer and the sheath layer in order to facilitate comparison of the Examples and Comparative Examples. Tables 1 to 3 show compositions of a base compound and a catalyst masterbatch (hereinafter, referred to as “catalyst MB”) and a compounding ratio of the two materials. Note that, LDPE means Low Density Polyethylene, MFR means Melt Flow Rate or fluidity index, and DCP means Dicumyl Peroxide.

TABLE 1
Composition of base compound

| | | | Compounding ratio |
|---|---|---|---|
| Type | | Substance | (mass %) |
| Base | Polymer | LDPE (density: 0.928, | 97.98 |
| compound | | MFR 2.0) | |
| | Silane compound | Vinylmethoxysilane | 2.00 |
| | Organic peroxide | DCP | 0.02 |

TABLE 2
Composition of catalyst masterbatch

| | | | Compounding ratio |
|---|---|---|---|
| Type | | Substance | (mass %) |
| Catalyst | Polymer | LDPE (density: 0.928, | 95 |
| MB | | MFR 2.0) | |
| | Condensation | Dibutyltin dilaurate | 5 |
| | catalyst | | |

TABLE 3
Formulation of base compound and catalyst masterbatch

| Type | Compounding ratio (mass %) |
|---|---|
| Base compound | 95 |
| Catalyst masterbatch | 5 |

Extruder and Extrusion Condition

In order to make trial products of coated wires using the above-mentioned materials, a single screw extruder satisfying the following conditions and a 5 m-long cooling water pool were used.

Each bore diameter of the extruder for the base compound and the catalyst MB is 60 mm and a L/D ratio of the extruder (L/D=cylinder length of extruder (L)/diameter of cylinder cross section of extruder (D)) is 25. Pellets formed of the base compound and the catalyst MB mixed and kneaded by the single screw extruder were used.

Silane Cross-Linking Conditions

The period of time when the grooved and non-grooved insulation layers are in cooling water in a cooling water pool was set to 15 seconds. Accordingly, an extrusion rate of the insulation layer was set to 20 m/min. After the grooved insulation layer was extrusion-formed and dipped in the water in the cooling water pool, the water on the outer peripheral surface of the grooved insulation layer was sufficiently drained by a non-illustrated air wipe.

Methods and Criteria for Evaluation

Following two methods and criteria for evaluation were used.

(1) Evaluation of Gel Fraction

A resin composition obtained by removing the grooved or non-grooved insulation layer from the finished coated wire was wrapped by a #40 mesh brass net and extraction was carried out in xylene at 110° C. for 24 hours. Next, after taking out from xylene and drying (air drying), vacuum drying was carried out at 80° C. for 4 hours. A gel fraction was calculated from weight before and after extraction based on the following formula 1. Since the gel fraction is an index of cross-linking progress, not less than 60% of gel fraction was judged as “passed”. The gel fraction was derived by the following formula.

Gel fraction(%)=100×(the amount of remaining resin after extraction)/(the amount of resin before extraction)

(2) Hot-Set Test

A test piece was made from the grooved or non-grooved insulation layer removed from the finished coated wire, and a hot-set test conforming to HS C 3660-2-1 was conducted in order to compare mechanical heat resistance of the coated wires. The test conditions are a test temperature of 200° C., a load of about 20 N/cm² and loading time of 15 minutes. The wire, in which elongation under load is not more than 100% and permanent elongation after cooling the test piece is not more than 25%, was judged as “passed”.

Evaluation Results

### (1) Gel Fraction

Table 4 shows evaluation results of the gel fraction over time of the grooved or non-grooved insulation layers in Example 1 to 3 and Comparative Examples 1 and 2. The gel fraction of not more than 60% is indicated by “X” (bad) and the gel fraction of not less than 60% is indicated by “◯” (good).

TABLE 4
Variation over time in gel fraction of grooved insulation layer or non-grooved insulation layer

| | | | | | | | Comparative | | Comparative | |
|---|---|---|---|---|---|---|---|---|---|---|
| | Example 1 | | Example 2 | | Example 3 | | Example 1 | | Example 2 | |
| Time | Gel | | Gel | | Gel | | Gel | | Gel | |
| elapsed | fraction | | fraction | | fraction | | fraction | | fraction | |
| (h) | (%) | Result | (%) | Result | (%) | Result | (%) | Result | (%) | Result |
| 0 | 30 | X | 35 | X | 25 | X | 20 | X | 25 | X |
| 3 | 20 | X | 35 | X | 60 | ◯ | 20 | X | 35 | X |
| 6 | 20 | X | 55 | X | 80 | ◯ | 20 | X | 55 | X |
| 12 | 20 | X | 60 | ◯ | 82 | ◯ | 20 | X | 70 | ◯ |
| 24 | 50 | X | 65 | ◯ | 85 | ◯ | 30 | X | 80 | ◯ |
| 48 | 55 | X | 70 | ◯ | 85 | ◯ | 40 | X | 80 | ◯ |
| 72 | 60 | ◯ | 70 | ◯ | 85 | ◯ | 50 | X | 80 | ◯ |
| 168 | 65 | ◯ | 70 | ◯ | — | | 50 | X | — | |
| 240 | 65 | ◯ | 70 | ◯ | — | | 50 | X | — | |
| 480 | 70 | ◯ | — | | — | | 50 | X | — | |
| (20 days) | | | | | | | | | | |
| 960 | 70 | ◯ | — | | — | | 50 | X | — | |
| (40 days) | | | | | | | | | | |
| 2160 | 70 | ◯ | — | | — | | 50 | X | — | |
| (90 days) | | | | | | | | | | |

Meanwhile, Table 5 shows time to achieve reference value (not less than 60%) of gel fraction.

TABLE 5
Time to achieve reference value of gel fraction of grooved insulation
layer or non-grooved insulation layer

| | Example | Example | Example | Comparative | Comparative |
|---|---|---|---|---|---|
| | 1 | 2 | 3 | Example 1 | Example 2 |
| Time to | 72 | 12 | 3 | Not achieved | 12 |
| achieve | | | | | |
| reference (h) | | | | | |

The coated wires in Examples 1, 2 and Comparative Example 1 were each stored in a storage unit adjusted to room temperature. Here, the cross-linking was not promoted in Comparative Example 1 and the gel fraction did not reach the reference value (not less than 60%) even after 3 months (90 days). On the other hand, the gel fraction reached the reference value after 72 hours (3 days) in Example 1 and after 12 hours in Example 2. In addition, the gel fraction eventually reached 70% in both Examples 1 and 2.

The coated wires in Example 3 and Comparative Example 2 were each stored in a thermostatic chamber adjusted to a temperature of 70° C. In both Example 3 and Comparative Example 2, the cross-linking was rapidly promoted and the gel fraction of not less than 80% was eventually obtained. However, the time to achieve reference value is greatly different between Example 3 and Comparative Example 2. It was revealed that it takes only 3 hours to reach the reference value in Example 3 but 12 hours in Comparative Example 2.

(2-1) Elongation under load in hot-set test

Table 6 shows evaluation results of elongation under load in Examples 1 to 3 and Comparative Examples 1 and 2. More than 100% of elongation under load is indicated by “X” (bad) and not more than 100% is indicated by “◯” (good).

TABLE 6
Elongation (%) under load in hot-set test

| | | | | | | | Comparative | | Comparative | |
|---|---|---|---|---|---|---|---|---|---|---|
| Time | Example 1 | | Example 2 | | Example 3 | | Example 1 | | Example 2 | |
| elapsed | Elongation | | Elongation | | Elongation | | Elongation | | Elongation | |
| (h) | (%) | Result | (%) | Result | (%) | Result | (%) | Result | (%) | Result |
| 0 | BRK | X | BRK | X | BRK | X | BRK | X | BRK | X |
| 3 | BRK | X | BRK | X | 80 | ◯ | BRK | X | BRK | X |
| 6 | BRK | X | 130 | X | 60 | ◯ | BRK | X | 150 | X |
| 12 | BRK | X | 90 | ◯ | 50 | ◯ | BRK | X | 70 | ◯ |
| 24 | 150 | X | 60 | ◯ | 40 | ◯ | BRK | X | 50 | ◯ |
| 48 | 110 | X | 50 | ◯ | 30 | ◯ | BRK | X | 40 | ◯ |
| 72 | 80 | ◯ | 40 | ◯ | 30 | ◯ | 180 | X | 40 | ◯ |
| 168 | 60 | ◯ | 40 | ◯ | — | | 180 | X | 40 | ◯ |
| 240 | 50 | ◯ | 40 | ◯ | — | | 160 | X | — | |
| 480 | 40 | ◯ | — | | — | | 160 | X | — | |
| (20 days) | | | | | | | | | | |
| 960 | 40 | ◯ | — | | — | | 160 | X | — | |
| (40 days) | | | | | | | | | | |
| 2160 | 40 | ◯ | — | | — | | 150 | X | — | |
| (90 days) | | | | | | | | | | |

BRK: broken

Meanwhile, Table 7 shows time to achieve reference value, until reaching the elongation under load of not more than 100%.

TABLE 7
Time to achieve reference value of elongation under load

| | Example | Example | Example | Comparative | Comparative |
|---|---|---|---|---|---|
| | 1 | 2 | 3 | Example 1 | Example 2 |
| Time to | 72 | 12 | 3 | Not achieved | 12 |
| achieve | | | | | |
| reference (h) | | | | | |

The coated wires in Examples 1, 2 and Comparative Example 1 were each stored in a storage unit adjusted to room temperature. Here, the cross-linking was not promoted in Comparative Example 1 and the elongation under load did not reach the reference value (not more than 100%) even after 3 months (90 days). On the other hand, the elongation under load reached the reference value after 72 hours (3 days) in Example 1 and after 12 hours in Example 2.

The coated wires in Example 3 and Comparative Example 2 were each stored in a thermostatic chamber adjusted to a temperature of 70° C. It was revealed that it takes only 3 hours to reach the reference value in Example 3 but 12 hours in Comparative Example 2.

Permanent Elongation After Cooled Down in Hot-Set Test

Table 8 shows evaluation results of permanent elongation (%) in Examples 1 to 3 and Comparative Examples 1 and 2 after cooled down. More than 25% of the permanent elongation after cooled down is indicated by “X” (bad) and not more than 25% is indicated by “◯” (good).

TABLE 8
Permanent elongation (%) after cooled down in hot-set test

| | | | | | | | Comparative | | Comparative | |
|---|---|---|---|---|---|---|---|---|---|---|
| Time | Example 1 | | Example 2 | | Example 3 | | Example 1 | | Example 2 | |
| elapsed | Elongation | | Elongation | | Elongation | | Elongation | | Elongation | |
| (h) | (%) | Result | (%) | Result | (%) | Result | (%) | Result | (%) | Result |
| 0 | BRK | X | BRK | X | BRK | X | BRK | X | BRK | X |
| 3 | BRK | X | BRK | X | 30 | X | BRK | X | BRK | X |
| 6 | BRK | X | 50 | X | 20 | ◯ | BRK | X | 70 | X |
| 12 | BRK | X | 30 | X | 15 | ◯ | BRK | X | 30 | X |
| 24 | 80 | X | 15 | ◯ | 10 | ◯ | BRK | X | 20 | ◯ |
| 48 | 40 | X | 10 | ◯ | 10 | ◯ | BRK | X | 15 | ◯ |
| 72 | 30 | X | 10 | ◯ | 10 | ◯ | 100 | X | 10 | ◯ |
| 168 | 20 | ◯ | 10 | ◯ | — | | 100 | X | 10 | ◯ |
| 240 | 15 | ◯ | 10 | ◯ | — | | 80 | X | — | |
| 480 | 15 | ◯ | — | | — | | 70 | X | — | |
| (20 days) | | | | | | | | | | |
| 960 | 10 | ◯ | — | | — | | 60 | X | — | |
| (40 days) | | | | | | | | | | |
| 2160 | 10 | ◯ | — | | — | | 60 | X | — | |
| (90 days) | | | | | | | | | | |

BRK: broken

Meanwhile, Table 9 shows time to achieve reference value, until reaching the permanent elongation of not more than 25%.

TABLE 9
Time to achieve reference value of permanent
elongation after cooled down

| | Example | Example | Example | Comparative | Comparative |
|---|---|---|---|---|---|
| | 1 | 2 | 3 | Example 1 | Example 2 |
| Time to | 168 | 24 | 6 | Not achieved | 24 |
| achieve | | | | | |
| reference (h) | | | | | |

The coated wires in Examples 1, 2 and Comparative Example 1 were each stored in a storage unit adjusted to room temperature. The cross-linking was not promoted in Comparative Example 1 and the permanent elongation after cooled down did not reach the reference value (not more than 25%) even after 3 months (90 days). On the other hand, the permanent elongation after cooled down reached the reference value after 168 hours (7 days) in Example 1 and after 24 hours (1 day) in Example 2.

The coated wires in Example 3 and Comparative Example 2 were each stored in a thermostatic chamber adjusted to a temperature of 70° C. It was revealed that it takes only 6 hours to reach the reference value in Example 3 but 24 hours (1 day) in Comparative

### Example 2

Overall Evaluation

Table 10 shows acceptable time to achieve the reference value in Examples 1 to 3 and Comparative Examples 1 and 2.

TABLE 10
Acceptable time to achieve the reference value (unit: time)

| | | Acceptable time to achieve the reference value (h) | | | | |
|---|---|---|---|---|---|---|
| Pass/Fail evaluation | | | | | Comparative | Comparative |
| items | | Example 1 | Example 2 | Example 3 | Example 1 | Example 2 |
| Gel fraction (>60%) | | 72 | 12 | 3 | >2160 | 12 |
| Hot-set test | Elongation | 72 | 12 | 3 | >2161 | 12 |
| | under load | | | | | |
| | (<100%) | | | | | |
| | Permanent | 168 | 24 | 6 | >2162 | 24 |
| | elongation after | | | | | |
| | cooled down | | | | | |
| | (<25%) | | | | | |

The coated wires in Examples 1, 2 and Comparative Example 1 were each stored in a storage unit adjusted to room temperature. It was not possible to obtain heat resistance acceptable in practical use in Comparative Example 1 even after 3 months (90 days). On the other hand, physical properties acceptable in practical use was obtained after 168 hours (7 days) in Example 1 and after 24 hours (1 day) in Example 2.

The coated wires in Example 3 and Comparative Example 2 were each stored in a thermostatic chamber adjusted to a temperature of 70° C. It was revealed that it takes only 6 hours to reach the reference value in Example 3 but 24 hours (1 day) in Comparative Example 2.

From the above, it was revealed that the cross-linking rate was remarkably improved in all of Examples 1 to 3. It was confirmed that the significant effects of reducing lead time and consumption energy which are required for manufacturing the coated wire are obtained especially in Example 3.

In other words, it was proved that the coated wires in Examples of the invention contribute to reduction of cross-linking time and improvement in adhesion of the coating layer.

It should be noted that the present invention is not intended to be limited to the embodiments, modifications and Examples, and the various kinds of modifications can be implemented without changing the gist of the present invention. For example, the constituent elements of each of the embodiments and each of the modifications can be arbitrarily combined without changing the gist of the present invention. In addition, the manufacturing processes described in the embodiments and the modifications are only an example, and it is possible to replace, delete, add and modify the steps without changing the gist of the invention.

What is claimed is:

1. A coated wire, comprising:
a core wire;
one or more grooved insulation layer coating the core wire, the grooved insulation layer comprising a silane-crosslinked insulating resin composition and a groove on an outer surface thereof; and
a sheath layer coating an outermost layer of the grooved insulation layer.

2. The coated wire according to claim 1, wherein the groove on the grooved insulation layer is formed along an axial direction of the core wire.

3. The coated wire according to claim 1, further comprising:
one or more non-grooved insulation layer comprising a silane-crosslinked insulating resin composition, the non-grooved insulation layer being formed between the grooved insulation layer and the sheath layer or between the core wire and the grooved insulation layer and having no groove on an outer surface thereof.

4. The coated wire according to claim 1, wherein the insulating resin composition composing the grooved insulation layer or the non-grooved insulation layer comprises a halogen-free flame-retardant thermoplastic composition.

5. A method of manufacturing a coated wire, comprising:
extruding an insulating resin composition from an extruder having a die with a convex portion on an inner surface thereof and located at an outlet port to coat a core wire with the insulating resin composition and adhering water to the insulating resin composition, the extrusion and the water adhesion being performed once or more than once, thereby forming one or more than one grooved insulation layers that coats the core wire and has a groove on an outer periphery thereof along an axial direction of the core wire; and
forming a sheath layer for coating the outermost periphery of the grooved insulation layer.

6. The method according to claim 5, further comprising:
extruding an insulating resin composition from an extruder on the fed core wire or on an outer periphery of a layer coating the core wire before or after forming the grooved insulation layer to coat the core wire or the grooved insulation layer with the insulating resin composition and adhering water to the insulating resin composition, the extrusion and the water adhesion performed once or more than once, thereby forming a non-grooved insulation layer that coats the core wire or the grooved insulation layer and does not have a groove on an outer periphery thereof.

7. The method according to claim 5, wherein a silane cross-linking reaction of the grooved insulation layer or the non-grooved insulation layer is enhanced by adhering water to a layer inside or outside of the grooved insulation layer or the non-grooved insulation layer.

8. The method according to claim 5, wherein the water is adhered by dipping in water in a cooling water pool.
